(19) United States
(12) Patent Application Publication
(10) Pub. No.: US 2016/0192209 A1
(43) Pub. Date: Jun. 30, 2016

(54) ANTENNA RADIATION PATTERN ADJUSTMENT AND MOBILE DEVICES

(71) Applicant: THOMSON LICENSING, Issy de Moulineaux (FR)

(72) Inventor: Mark Francis Rumreich, Indianapolis, IN (US)

(73) Assignee: Thomson Licensing

(21) Appl. No.: 14/962,053

(22) Filed: Dec. 8, 2015

Related U.S. Application Data
(60) Provisional application No. 62/098,372, filed on Dec. 31, 2014.

(51) Int. Cl. H04W 16/28; H04W 8/22; H04L 12/24; H04W 16/18

(52) U.S. Cl. CPC H04W 16/28; H04W 16/18; H04W 8/22; H04L 41/22

(57) ABSTRACT

A radiation or reception pattern of an electronically steerable antenna is adjusted based at least partially on whether at least one device or node is mobile or static. Mobile devices are identified and a radiation pattern generated by a gateway antenna is adjusted accordingly to optimize communications between the gateway and mobile device. Movements of the mobile devices can be traced so that a radiation pattern can be further adapted as the device moves.

### TECHNICAL FIELD

The present principles relate generally to gateway systems, and more particularly, to an apparatus and method for adjusting radiation patterns generated by a gateway antenna.

### BACKGROUND

Gateways, such as cable modems or wireless routers, allow users to connect computing devices to the Internet or other wide area networks (“WAN”). Such gateways can include wired and/or wireless interfaces to a home or local area network (“LAN”). The interface to the LAN allows the gateways to communicate with other devices (e.g., computers, tablets, set top boxes, internet enabled appliances, etc.). Many available gateways also provide a number of operational features to enhance the wide array of possible applications. For example, these gateways can permit a user to modify settings in the gateway during use. The gateway settings can be modified through a web browser accessed through the gateway or through a separate device. The gateway applications may also mimic functions that can be performed through a browser.

### SUMMARY

In order to improve the range of gateways, some manufacturers have begun to incorporate electronically steerable antennas into these gateways. These antennas can be configured to focus the radio frequency (“RF”) energy in a certain direction. Using steerable antennas in gateways can improve the RF coverage inside a structure and can reduce the interference caused by physical obstacles that could block the signal. Thus, such gateways attempt to optimize the radiation pattern of the RF signal emanating from the gateway antenna. However, typical networks can include an assortment of devices, such as stationary and mobile devices. While steerable antennas can be configured to cover a particular area, mobile devices can periodically move in and out of the covered area. Thus, fixed radiation patterns of conventional gateways can be unsuitable in many situations.

In view of the foregoing, disclosed herein are an apparatus and method for adjusting the radiation patterns of a gateway antenna. In one aspect, an apparatus can comprise an electronically steerable antenna to provide wireless communication to at least one remote device. In another aspect, the apparatus can comprise at least one processor to identify whether the at least one remote device is a mobile device type or a static device type and adjust a radiation pattern or a reception pattern of the electronically steerable antenna based at least partially on whether the at least one remote device is the mobile device type or the static device type.

In another example, at least one processor of the apparatus can also be configured to detect a message from at least one remote device, the message indicating whether the at least one remote device is the mobile device type or the static device type and identify whether the at least one remote device is the mobile device type or the static device type based at least partially on the message.

In a further aspect, at least one processor of the apparatus can also be configured to identify whether the at least one remote device is the mobile device type or the static device type based at least partially on information associated with at least one media access control address corresponding to the at least one remote device.

In yet another example, at least one processor of the apparatus can be further configured to identify characteristics of the at least one remote device in order to identify whether the at least one remote device is the mobile device type or the static device type, the characteristics comprising signal strength or movement of the at least one remote device.

In another aspect, at least one processor can be configured to generate a configuration screen suitable for rendering on a display and identify whether the at least one remote device is the mobile device type or the static device type based at least partially on information received via the configuration screen.

A method of adjusting a radiation pattern of a gateway antenna is also provided herein. In one example, the method can include identifying, using at least one processor, whether at least one remote device is a mobile device type or a static device type; and adjusting, using the at least one processor, a radiation pattern or a reception pattern of an electronically steerable antenna such that the adjusting is based at least partially on whether the at least one remote device is the mobile device type or the static device type.

Also provided herein is a gateway apparatus. In one aspect, the gateway apparatus can include an electronically steerable antenna to provide wireless communication to at least one node in a local area network and at least one processor to identify whether each node in the local area network is a mobile device or a static device and adjust a radiation pattern or a reception pattern of the electronically steerable antenna based at least partially on whether the at least one node is a mobile device or a static device.

The apparatus and method disclosed herein can further reduce the interference of household obstacles by adjusting radiation patterns so that improved RF coverage is provided for mobile devices. The aspects, features and advantages of the present principles will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

FIG. 1 depicts a block diagram of an exemplary gateway system in accordance with an embodiment of the present principles.

FIG. 2 depicts a close up illustration of an exemplary residential gateway in accordance with an embodiment of the present principles.

FIG. 3 depicts a flow diagram of an example method in accordance with an embodiment of the present principles.

FIG. 4 depicts a working example in accordance with an embodiment of the present principles.

FIG. 5 depicts a further working example in accordance with an embodiment of the present principles.

FIG. 6 depicts yet a further working in accordance with an embodiment of the present principles.

FIG. 7 depicts exemplary radiation patterns in accordance with an embodiment of the present principles.

### DETAILED DESCRIPTION

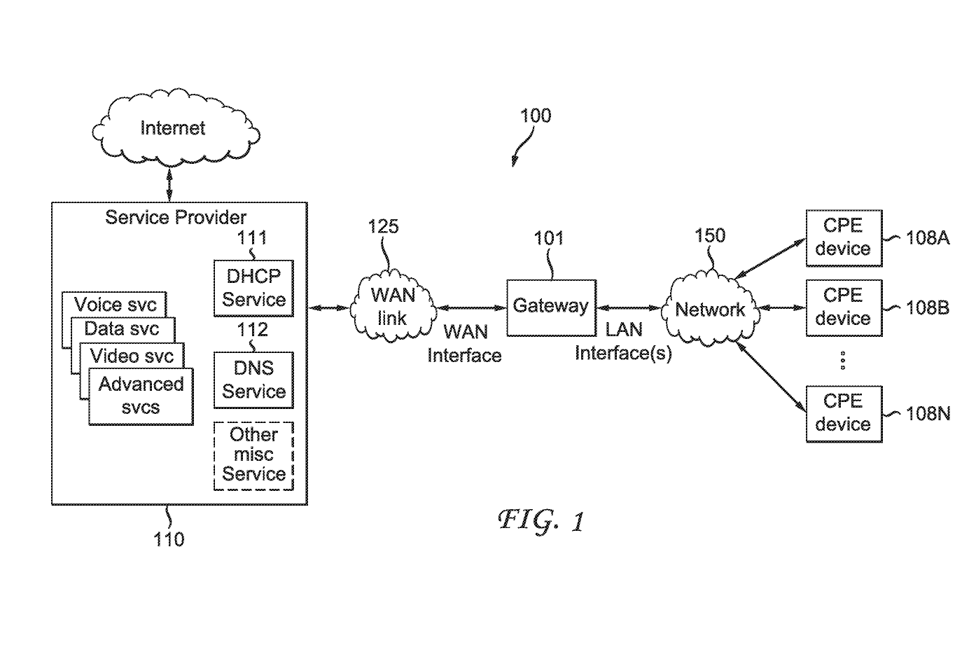

FIG. 1 is a block diagram of an example networking communication system 100. In this example, gateway 101 can be an advanced cable gateway, cable modem, DSL modem and the like. Gateway 101 is illustrated as being coupled to a WAN link 125 through a WAN interface to service provider 110. The WAN link 125 can be any communication link including, but not limited to, coaxial cable, fiber optic cable, telephone line, or over the air links. Gateway 101 can also be coupled to a network 150 via a LAN interface. Network 150 can comprise one or more networked customer premises equipment (“CPE”) devices 180A-N. The network 150 can include a wireless link or wired links, such as co-axial cable or Ethernet. CPE devices 180A-N can include, but are not limited to, personal computers, smartphones, tablet PCs, network printers, digital set-top boxes and the like.

Service provider 110 can provide one or more services to CPE devices 180, such as voice, data, and audio, over WAN link 125, through gateway 101 and the LAN interface. Service provider 110 can include internet related services and server structures such as a dynamic host configuration protocol (“DHCP”) server 111 and domain name system (“DNS”) server 112, and can include other servers and services as well (e.g., video on demand, news, weather). These servers and services can be co-located or widely distributed, physically and/or virtually, in both hardware and software. In an illustrative cable application, service provider 110 can be, for example, a cable multiple service operator (“MSO”).

Gateway 101 can be the interface between the WAN link 125 external to a customer's structure and the network 150 located, for example, in the customer's home. Gateway 101 can convert transport data packets, such as packets in an IP protocol, from a form used in the WAN to a format used in the network or LAN. Gateway 101 can also route data packets, including the converted data packets between the WAN and one or more devices on the network. Gateway 101 can include interfaces for both wired networking (e.g., Ethernet or Multimedia over Coaxial cable Alliance) and wireless networking. Gateway 101 can allow data, voice, video and audio communication between the WAN and CPE devices 180A-N used in, for example, a customer's home and/or business, etc. (i.e., structure), such as analog telephones, televisions, computers, and the like.

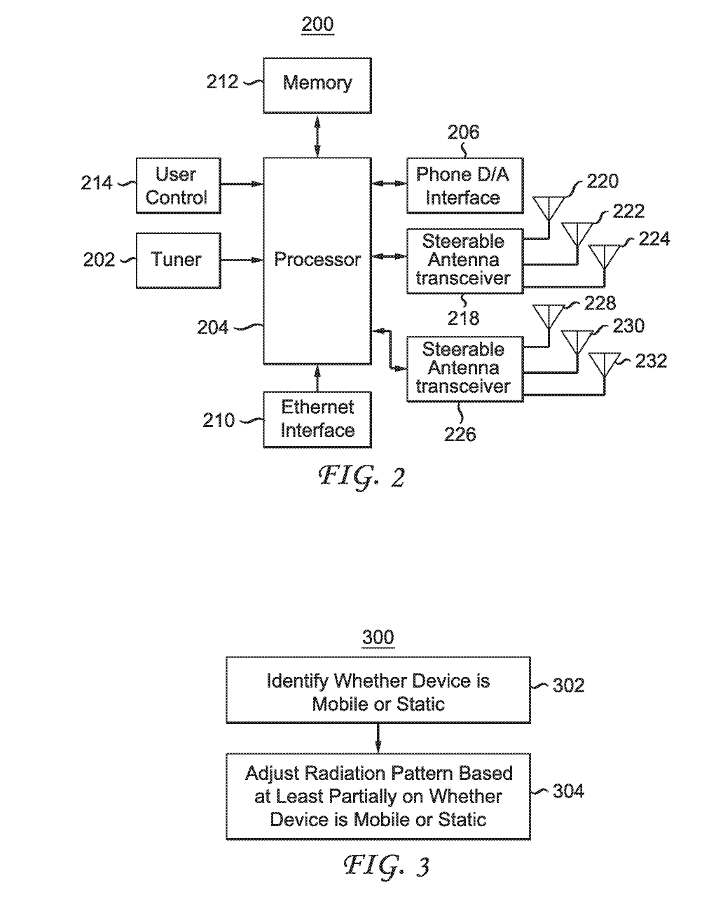

Referring now to FIG. 2, a block diagram of an illustrative gateway 200 is shown. Gateway 200 can correspond to gateway 101 described in FIG. 1. It should be understood that the elements shown in the drawings can be implemented in various forms of hardware, software or a combination or hardware and software. It is also understood that the hardware can include at least one processor, memory and input/output interfaces. Herein, the phrase “coupled” can be defined as being directly connected to or indirectly connected with one or more intermediate components. Such intermediate components can include both hardware and software based components.

In gateway 200, an RF signal can be detected by tuner 202. Steerable antenna transceiver 218 can further include antennas 220, 222, 224 and steerable antenna transceiver 226 can include antennas 228, 230 and 232. Tuner 202 can be coupled to central processor unit 204. In turn, central processor unit 204 can be coupled to phone D/A interface 206, steerable antenna transceiver 218, steerable antenna transceiver 226, Ethernet interface 210, system memory 212, and user control interface 214. Gateway 200 can be capable of operating as an interface to a cable or DSL communication network and further can be capable of providing an interface to one or more devices connected through a wired or wireless network. Central processor unit 204 can be any number of processors, such as processors from Intel® Corporation and the like. In another example, central processor unit 204 can be contained within an application specific integrated circuit (“ASIC”).

A signal, such as a cable or DSL signal on the WAN, can be interfaced to tuner 202 through a detected RF input. Tuner 202 can carry out RF modulation functions on a signal provided to the WAN and demodulation functions on a signal received from the WAN. Central processor unit 204 can read the demodulated cable or DSL signals and digitally process the signals from tuner 202 to provide voice and data for the interfaces in gateway 200. Similarly, central processor unit 204 can also process and direct any voice signals and data received from any of the nodes on the LAN for delivery to tuner 202 and transmission to the WAN.

System memory 212 can support the processing in central processor unit 204 and can also serve as storage for program and data information. Processed and/or stored digital data from central processor unit 204 can be available for transfer to and from Ethernet interface 210. Ethernet interface 210 can support, for example, a Registered Jack type RJ-45 physical interface connector or other standard interface connector and allow connection to an external local computer. Processed and/or stored digital data from central processor unit 204 can also be available for digital to analog conversion in phone D/A interface 206. Interface 206 can allow connection to an analog telephone handset. In one example, this physical connection is provided via an RJ-11 standard interface, but other interface standards can be used. Processed and/or stored digital data from central processor unit 204 is additionally available for exchange through steerable antenna transceivers 218 and 226. Steerable antenna transceivers 218 and 226 can support multiple operations across networked devices simultaneously. Central processor unit 204 can also receive and process user input signals provided via user control interface 214, which can include a display and/or a user input device such as a hand-held remote control and/or other type of user input device.

Steerable antenna transceivers 218 and 226 can provide and receive data to and from network devices in, for example, the 2.4 GHz and 5 GHz band respectively (one skilled in the art can appreciate that different operational frequencies can be utilized by the present principles as well). Thus, gateway 200 can provide wireless communication to older devices enabled for 2.4 GHz wireless communication and newer devices enabled for higher throughput using 5 GHz wireless communication (and even higher frequencies). The antennas 220, 222, 224 can be configured as a first phased array of antennas and antennas 228, 230, and 232 can be configured as a second phased array. In this example, the phases of the signals output to each antenna array can be adjusted so that the radiation pattern generated by each array is intensified in a desired direction and reduced in an undesired direction. Such an adjustment can also be used to optimize a reception pattern of signals detected from devices in the wireless network. The radiation pattern and reception pattern techniques of the steerable antennas are discussed in more detail below. Devices employing multiple antennas and in some cases multiple transceivers or transmit/receive circuits, such as cable or DSL gateways described above or other networking devices, can operate in a number of transmit and receive modes. In the example of FIG. 2, more than one antenna (using one or more transceiver circuits) is used for transmission and reception, which is known as multiple-input-multiple-output (MIMO) mode.

As noted above, gateway 200 can comprise phased array antennas that can employ multiple transceiver circuits and allow operation using multiple antennas. In one example, each transmitter circuit and each receiver circuit can be attached to more than one antenna. In another example, a combined transceiver circuit can be connected to more than one antenna. In yet another example, more than one combined transceiver circuit can each be connected to one or more antennas. In each of these examples, wireless communication performance between the gateway or modem and network client device (e.g., computer, tablet, and appliance) can be governed in part by the position and location of a particular antenna and the adjustment of phases of each antenna.

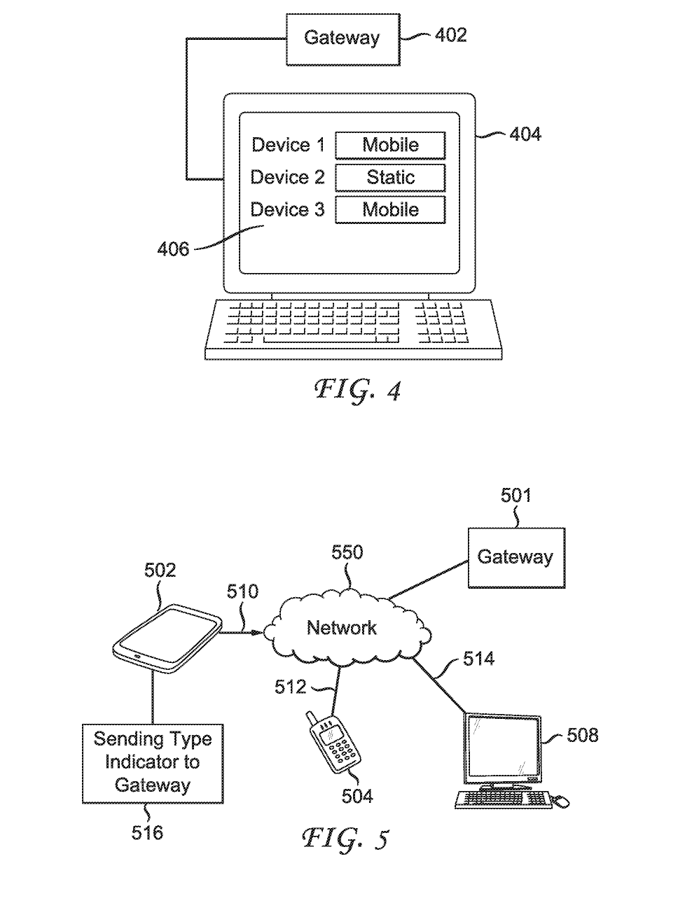

Working examples of the apparatus and method are shown in FIGS. 3-7. In particular, FIG. 3 illustrates a flow diagram of an exemplary method 300 for adjusting the radiation pattern of a gateway. FIGS. 4-7 are working examples corresponding to the flow diagram of FIG. 3. The actions shown in FIGS. 4-7 are discussed below with regard to the flow diagram of FIG. 3.

Referring now to FIG. 3, it is identified whether a device in a LAN network is a mobile type or static type device, as shown in block 302. For example, it can be identified whether a device is a tablet (i.e., mobile type) or a desktop (i.e., static type). This can be determined in a variety of ways. For example, FIG. 4 illustrates one example of determining whether a given node in the LAN is a mobile or static device. Gateway 402 shown in FIG. 4 can also correspond to gateway 101 in FIG. 1. In this example, gateway 402 can be configured using a device 404. Device 404 can be a desktop computer coupled to gateway 402 in a wired configuration. However, it is understood that any other device can be coupled to gateway 402 and that the coupling can be implemented wirelessly. Gateway 402 can scan the LAN and display each CPE device detected. The example of FIG. 4 also illustrates a configuration screen 406 that allows a user to specify whether each node detected in the LAN is static or mobile. Configuration screen 406 can, for example, be rendered using a browser or can be a standalone application. Once a user specifies the type of each device detected in the LAN, the settings can be saved in a non-volatile memory in gateway 402 or to a memory external to gateway 402. In turn, the gateway 402 can adjust the radiation patterns of its steerable antenna arrays accordingly by adjusting the phase and amplitude of one or more antenna elements.

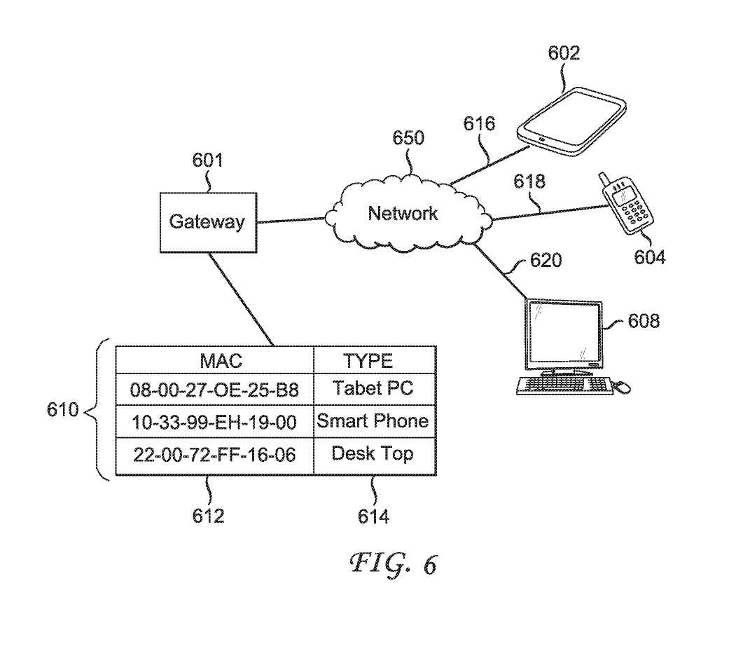

Referring now to FIG. 5, another working example of determining the type of devices in a network is shown. This example shows gateway 501, which can correspond to gateway 101 in FIG. 1, connected to a network 550, which can correspond to network 150 of FIG. 1. FIG. 5 also shows three devices 502, 504, and 508 connected to network 550 via wireless links 510, 512, and 514 respectively. In this example, each device 502, 504, and 508 can connect to gateway 501 using an interface and identify itself as being mobile or static. FIG. 5 shows an example interface 516 that permits a user to send a message to gateway 501 indicating whether the device in use is mobile or static. Here, device 502 sends a message to gateway 501 over network 550 with the indicator. In turn, gateway 501 can store this information in a local or remote non-volatile memory.

Referring now to FIG. 6, another example of determining whether a node in a LAN is mobile or static is shown. In this example, gateway 601, which can also correspond to gateway 101, can obtain a media access control (“MAC”) address corresponding to each device 602, 604 and 608 connected to network 650 via wireless links 616, 618 and 620 respectively. Gateway 601 can then lookup information associated with the MAC address in MAC database 610. MAC database 610 can be, for example, an external (e.g., database accessible via the Internet) or internal database (e.g., database in a memory of the gateway). MAC database 610 can have a column 612 containing the MAC address associated with each device and column 614 containing information corresponding to each device. The information in column 614 can indicate whether the device corresponding to each MAC address is mobile or static. For example, an entry of “Tablet PC” or “smart phone” in column 614 can indicate that the MAC address associated with the entry is a mobile device type; furthermore, an entry of “Desk Top” in column 614 can indicate that the MAC address associated with the entry is a static device type.

In another example, gateway 601 can determine whether a device is static or mobile based at least partially on characteristics of each device in the network. The characteristics can comprise received signal strength (“RSS”) to determine movement of each device. In one example, one or more processors of gateway 601 can take a series of RSS signal measurements for each device and determine whether the device is mobile based on a difference between one or more pairs of RSS measurements. In one example, a large difference between one or more pairs of RSS measurements can indicate that the mobile device being measured is a mobile device type. On the contrary, if the RSS is relatively stable, it can be determined that the device is stationary.

Referring back to FIG. 3, the radiation pattern or reception pattern can be adjusted based at least partially on whether each device is a mobile or static type, as shown in block 304. In a further example, the steerable antennas of the gateway device can measure a direction of a received signal to determine a location of a device and to track a device as it moves. Such measurement can comprise methods including, but not limited to, multiple signal classification (“MUSIC”), estimation of signal parameters via rotational invariance techniques (“ESPRIT”), the matrix pencil method, or derivatives thereof. Once a device is deemed mobile, it can be traced and the phased arrays of the steerable antennas can be adjusted in accordance with the direction and location of the device as it moves throughout the premise to improve the transmission and reception to and from the mobile device. In one example, the steerable antenna transceivers 218 and 226 shown in FIG. 2 can be switched beam antennas with several available radiation patterns so that the desired beams are selected and strengthened when a device is detected in the area covered by the beam. In a further example, steerable antenna transceivers 218 and 226 can be adaptive so that the phase and amplitude of each antenna element is adjusted as the device moves.

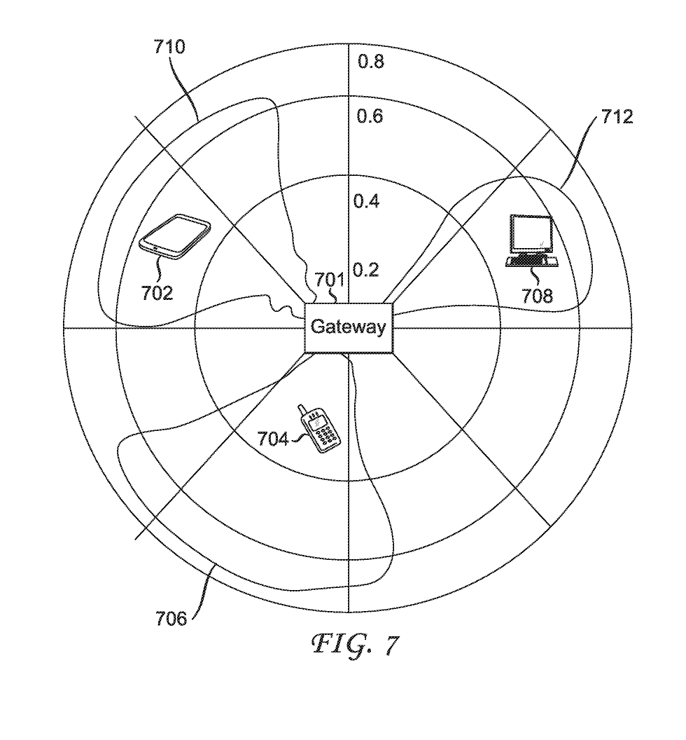

Referring now to FIG. 7, illustrative radiation patterns generated by gateway 701 are shown. Gateway 701 can also correspond to gateway 101 of FIG. 1. FIG. 7 also shows normalized distance measurements (e.g., 0.2, 0.4, 0.6, and 0.8) from gateway 701. In the example of FIG. 7, mobile device 702 and mobile device 704 can be a tablet and a phone respectively and static device 708 can be a desktop. For static device 708, a radiation pattern 712 can be aimed directly at static device 708. Furthermore, the reception pattern of the steerable antennas can also be adjusted to receive signals from that same direction. For example, the reception pattern can be adjusted by weighing the signal strength of a received signal detected by one or more antenna elements using an appropriate phase and amplitude coefficient. For mobile devices 702 and 704, radiation patterns 710 and 706 can be generated for each device respectively. Radiation patterns 706 and 710 have perturbations that cover a wider area. If mobile device 702 and/or 704 moves out of the covered area, the steerable antennas can detect the movement and can move the radiation pattern as the device moves.

In another example, when gateway detects a movement of a mobile device, the mobile device on the LAN can notify the gateway of the signal strength received from the steerable antennas. By way of example, gateway 701 of FIG. 7 can transmit a signal strength request to mobile device 702, when a movement of mobile device 702 is detected by gateway 701; in response, mobile device 702 can transmit to gateway 701 the signal strength currently detected by mobile device 702 from the gateway 701. If the signal strength detected by mobile device 702 falls below a predetermined threshold (e.g., approximately 80%), the gateway 701 can adjust the radiation pattern and request another signal strength indicator from the mobile device 702. This process can continue until the signal strength detected by mobile device 702 from gateway 701 exceeds the threshold. That is, the gateway 701 can continue adjusting the radiation pattern of the steerable antennas until the threshold is exceeded. In yet another example, mobile device 702 can automatically send a radiation pattern adjustment request to gateway 701, when the signal strength received from gateway 701 falls below the threshold. In this instance, gateway 701 can readjust the radiation pattern and mobile device 702 can either send another request, if the adjustment did not cause the signal strength to exceed the threshold, and/or can stop further requests, if the adjustment caused the signal strength to exceed the threshold.

Advantageously, the foregoing apparatus and method allow RF beams to be optimally aimed at devices in a LAN network. In this regard, mobile devices can be identified and the radiation patterns generated by a gateway antenna can be adjusted accordingly. Furthermore, movements of the mobile devices can be traced so that the radiation patterns can be further optimized as the devices move. In turn, users can have optimal throughput on their devices regardless of their location within a structure.

The functions of the various elements shown in the figures may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Any switches shown in the figures are conceptual only. Their function may be carried out through the operation of program logic, through dedicated logic, through the interaction of program control and dedicated logic, or even manually; the particular technique being selectable by the implementer as more specifically understood from the context.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. An apparatus comprising:
an electronically steerable antenna that provides wireless communication to at least one remote device; and
at least one processor configured to identify whether the at least one remote device is a mobile device type or a static device type and adjust at least one of a radiation pattern or a reception pattern of the electronically steerable antenna based at least partially on whether the at least one remote device is the mobile device type or the static device type.

2. The apparatus of claim 1, wherein the at least one processor is further configured to detect a message from the at least one remote device, the message indicating whether the at least one remote device is the mobile device type or the static device type and identify whether the at least one remote device is the mobile device type or the static device type based at least partially on the message.

3. The apparatus of claim 1, wherein the at least one processor is further configured to identify whether the at least one remote device is the mobile device type or the static device type based at least partially on information associated with at least one media access control address corresponding to the at least one remote device.

4. The apparatus of claim 1, wherein the at least one processor is further configured to identify characteristics of the at least one remote device in order to identify whether the at least one remote device is the mobile device type or the static device type, the characteristics comprising signal strength or movement of the at least one remote device.

5. The apparatus of claim 1, wherein the at least one processor is further configured to generate a configuration screen suitable for rendering by a display and identify whether the at least one remote device is the mobile device type or the static device type based at least partially on information received via the configuration screen.

6. A method, comprising:
identifying, using at least one processor, whether at least one remote device is a mobile device type or a static device type; and
adjusting, using the at least one processor, at least one of a radiation pattern or a reception pattern of an electronically steerable antenna such that the adjusting is based at least partially on whether the at least one remote device is the mobile device type or the static device type.

7. The method of claim 6, wherein the identifying further comprising:
detecting, using the at least one processor, a message from the at least one remote device, the message indicating whether the at least one remote device is the mobile device type or the static device type.

8. The method of claim 6, wherein the identifying further comprising:
identifying, using the at least one processor, whether the at least one remote device is the mobile device type or the static device type based at least partially on information associated with at least one media access control address corresponding to the at least one remote device.

9. The method of claim 6, wherein the identifying further comprising:
detecting characteristics of the at least one remote device, the characteristics comprising signal strength or movement of the at least one remote device.

10. The method of claim 6, wherein the identifying further comprising:
generating, using at least one processor, a configuration screen suitable for rendering on a display; and
detecting, using the at least one processor, information received via the configuration screen, the information indicating whether the at least one remote device is the mobile device type or the static device type.

11. A residential gateway apparatus, comprising:
an electronically steerable antenna to provide wireless communication to at least one node in a local area network; and
at least one processor to identify whether each node in the local area network is a mobile device or a static device and adjust at least one of a radiation pattern or a reception pattern of the electronically steerable antenna based at least partially on whether the at least one node is a mobile device or a static device.

12. The residential gateway apparatus of claim 11, wherein the at least one processor is further configured to identify whether each node in the local area network is the mobile device or the static device based at least partially on information associated with a media access control address corresponding to each node in the local area network.

13. The residential gateway apparatus of claim 11, wherein the at least one processor is further configured to identify characteristics of each node in the local area network in order to identify whether each node is a mobile device or a static device, the characteristics comprising signal strength or movement of each node.

14. The residential gateway apparatus of claim 11, wherein the at least one processor is further configured to generate a configuration screen suitable for rendering on a display and identify whether each node in the local area network is a mobile device or a static device based at least partially on information received via the configuration screen.

15. A method comprising:
identifying, using at least one processor, whether each node in a local area network is a mobile device or a static device; and
adjusting, using the at least one processor, at least one of a radiation pattern or a reception pattern of an electronically steerable antenna such that the adjusting is based at least partially on whether each node in the local area network is a mobile device or a static device.

16. The method of claim 15, wherein the identifying further comprising:
identifying, using the at least one processor, whether each node in the local area network is a mobile device or a static device based at least partially on information associated with a media access control address corresponding to each node.

17. The method of claim 15, wherein the identifying further comprising:
detecting characteristics of each node of the local area network, the characteristics comprising signal strength or movement of each node.

18. The method of claim 15, further comprising:
generating, using the at least one processor, a configuration screen suitable for rendering by a display; and
detecting, using the at least one processor, information received via the configuration screen, the information indicating whether a given node of the local area network is a mobile device or a static device.
